(19) United States
(12) Patent Application Publication
(10) Pub. No.: US 2010/0268761 A1
(43) Pub. Date: Oct. 21, 2010

(54) METHODS AND SYSTEMS FOR DELIVERY OF MEDIA OVER A NETWORK

(76) Inventor: Steve Masson, San Jose, CA (US)

Correspondence Address: Steve Masson, 720 Saratoga Ave Apt V201, San Jose, CA, 95129, US

(21) Appl. No.: 12/451,863

(22) PCT Filed: Sep. 19, 2007
(86) PCT No.: PCT/CA2007/001677

§ 371 Date: Dec. 2, 2009

Related U.S. Application Data
(60) Provisional application No. 60/942,006, filed on Jun. 5, 2007.

(51) Int. Cl. G06F 15/16

(52) U.S. Cl. 709/203; 709/231

(57) ABSTRACT

A media delivery platform, which comprises a control entity and a data path entity. The control entity is configured for receiving over a control session media action commands from a client, the media action commands specifying a media object stored in a media storage entity; determining object location information allowing the specified media object to be retrieved from the media storage entity; and providing the data path entity with the object location information. For its part, the data path entity is configured for piecewise retrieval of the media object from the media storage entity based on the object location information; and piecewise transmission of the media object to the client, the transmission being effected over a data session separate from the control session.

### CROSS-REFERENCE TO RELATED APPLICATION

The present invention claims the benefit under 35 USC §119(e) of prior U.S. provisional patent application Ser. No. 60/942,006 to Steve Masson, filed on Jun. 5, 2007, hereby incorporated by reference herein.

### FIELD OF THE INVENTION

The present invention relates generally to communication of media over networks such as the Internet and, more particularly, to methods and systems for enabling the delivery of media over such networks.

### BACKGROUND

As the number of people who have high-speed access to the Internet increases, so too does the demand for online access to media, such as movies on demand. The supply of media over the Internet has followed a similar upwards trend. Thus, the Internet has become populated with ever increasing numbers of content providers that offer the delivery of media to those clients who have sufficiently large bandwidth “pipes”.

A conventional architecture for delivering media over the Internet has been to provide a streaming “media server” behind a World Wide Web portal. The media server interfaces with clients over the Internet who select a movie (or other content) and then provide a command to begin its playback. The media server then accesses a storage area network (SAN) to retrieve the movie, which is then expected to be delivered to the client at speeds of up to 10 Mb/s or more. The media server ensures that the data is compressed into a client-suitable format, and may perform other processing functions. In addition, the media server responds to commands received from the client during playback, such as “skip back”, “skip forward” and “stop”, and responds accordingly.

While such a conventional architecture works satisfactorily for low volumes of clients, it has serious drawbacks as the number of clients increases. In particular, the involvement of the media server at all levels of processing and control creates a bottleneck that will begin to impair the delivery of media at data rates falling well below that which may effectively be available to clients over the Internet. This begs the use of more powerful media servers, which are sophisticated devices and therefore are costly. Even so, this is only a provisional solution, since a continued increase in the number of clients will eventually cause even the most powerful media server to reach its processing limits. The installation of additional media servers then becomes not only a more costly solution, but one which has an additional layer of complexity from the point of view of managing the increased number of servers, the load among servers, the shared access among servers, the increased number of failures, and so on.

Thus, conventional solutions based on traditional media servers tend to be very costly and do not scale well, thus making them poorly adapted to handle the forecasted increase in demand for online access to media. Hence, there is a need for improved methods and systems for the delivery of media over the Internet.

### SUMMARY OF THE INVENTION

According to a first broad aspect, the present invention seeks to provide a data path device, comprising an interface configured to receive object location information from a control entity in communication with a client over a control session, said object location information allowing retrieval of a media object from a media storage entity; and a data path subsystem configured to effect piecewise retrieval of said media object from said media storage entity based on said object location information and to effect piecewise transmission of said media object to said client over a data session separate from said control session.

According to a second broad aspect, the present invention seeks to provide a data path device, comprising means for receiving object location information from a control entity in communication with a client over a control session, said object location information allowing retrieval of a media object from a media storage entity; means for effecting piecewise retrieval of said media object from said media storage entity based on said object location information; and means for effecting piecewise transmission of said media object to said client over a data session separate from said control session.

According to a third broad aspect, the present invention seeks to provide a method, comprising receiving object location information from a control entity in communication with a client over a control session, said object location information allowing retrieval of a media object from a media storage entity; effecting piecewise retrieval of said media object from said media storage entity based on said object location information; and effecting piecewise transmission of said media object to said client over a data session separate from said control session.

According to a fourth broad aspect, the present invention seeks to provide a media delivery platform, comprising a control entity; and a data path entity. The control entity is configured for receiving over a control session media action commands from a client, said media action commands specifying a media object stored in a media storage entity; determining object location information allowing the specified media object to be retrieved from said media storage entity; and providing said data path entity with said object location information. The data path entity is configured for piecewise retrieval of said media object from said media storage entity based on said object location information; and piecewise transmission of said media object to said client, said transmission being effected over a data session separate from said control session.

According to a fifth broad aspect, the present invention seeks to provide a media delivery platform, comprising means for receiving over a control session media action commands from a client, said media action commands specifying a media object stored in a media storage entity; means for determining object location information allowing the specified media object to be retrieved from said media storage entity; means for effecting piecewise retrieval of said media object from said media storage entity based on said object location information; and means for effecting piecewise transmission of said media object to said client, said transmission being effected over a data session separate from said control session.

According to a sixth broad aspect, the present invention seeks to provide a method, comprising receiving over a control session media action commands from a client, said media action commands specifying a media object stored in a media storage entity; determining object location information allowing the specified media object to be retrieved from said media storage entity; effecting piecewise retrieval of said media object from said media storage entity based on said object location information; and effecting piecewise transmission of said media object to said client, said transmission being effected over a data session separate from said control session.

According to a seventh broad aspect, the present invention seeks to provide a method for delivery of stored media to a client, comprising receiving commands over a control session; retrieving the stored media from a media storage entity based on said commands; and delivering the retrieved media to a client over a data session that is separate from the control session.

According to an eighth broad aspect, the present invention seeks to provide a method for execution at a media client, comprising sending media commands to a control entity over a control session established with the control entity; and receiving streamed media from a data path entity over a data session established with the data path entity, the streamed media having bypassed the control entity while identifying the control entity as an originator of the streamed media.

According to a ninth broad aspect, the present invention seeks to provide a media client comprising a media engine configured to send media commands to a control entity over a control session established with the control entity, and to receive streamed media from a data path entity over a data session established with the data path entity, the streamed media having bypassed the control entity while identifying the control entity as an originator of the streamed media.

According to a tenth broad aspect, the present invention seeks to provide a bank of data path devices, each said data path being independently accessible and comprising: an interface configured to receive object location information from a control entity in communication with a client over a control session, said object location information allowing retrieval of a media object from a media storage entity; and a data path subsystem configured to effect piecewise retrieval of said media object from said media storage entity based on said object location information and to effect piecewise transmission of said media object to said client over a data session separate from said control session.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIGS. 1A-1C show various non-limiting example embodiments of an architecture for the delivery of media over a network, including a media control server and a plurality of data path devices;

FIG. 2 is a block diagram illustrating various components of the media control server of FIGS. 1A, 1B and 1C, in accordance with a non-limiting example embodiment of the present invention;

FIG. 3 shows a state machine indicative of state transitions possible for a give data session established with a data path device, in accordance with a non-limiting example embodiment of the present invention;

FIG. 4 is a block diagram illustrating various components of one of the data path devices of FIGS. 1A, 1B and 1C, in accordance with a non-limiting example embodiment of the present invention;

FIG. 5 provides a summary of certain example messages that can be exchanged between the media control server and the data path devices of FIGS. 1A, 1B and 1C, in accordance with a non-limiting example embodiment of the present invention;

FIG. 6 depicts the manner in which a media object is mapped to a file allocation table in a memory of one of the data path devices of FIGS. 1A, 1B and 1C, as well as the manner in which the contents of an ingress packet buffer is mapped to virtual file buffers in the memory, in accordance with a non-limiting example embodiment of the present invention;

FIG. 7 illustrates a shared access mechanism used by one of the data path devices of FIGS. 1A, 1B and 1C, in accordance with a non-limiting example embodiment of the present invention; and

FIG. 8 depicts an operational example, whereby an end user utilizes a media client to play back stored media, in accordance with a non-limiting example embodiment of the present invention.

It is to be expressly understood that the description and drawings are only for the purpose of illustration of certain embodiments of the invention and are an aid for understanding. They are not intended to be a definition of the limits of the invention.

### DETAILED DESCRIPTION OF NON-LIMITING EMBODIMENTS

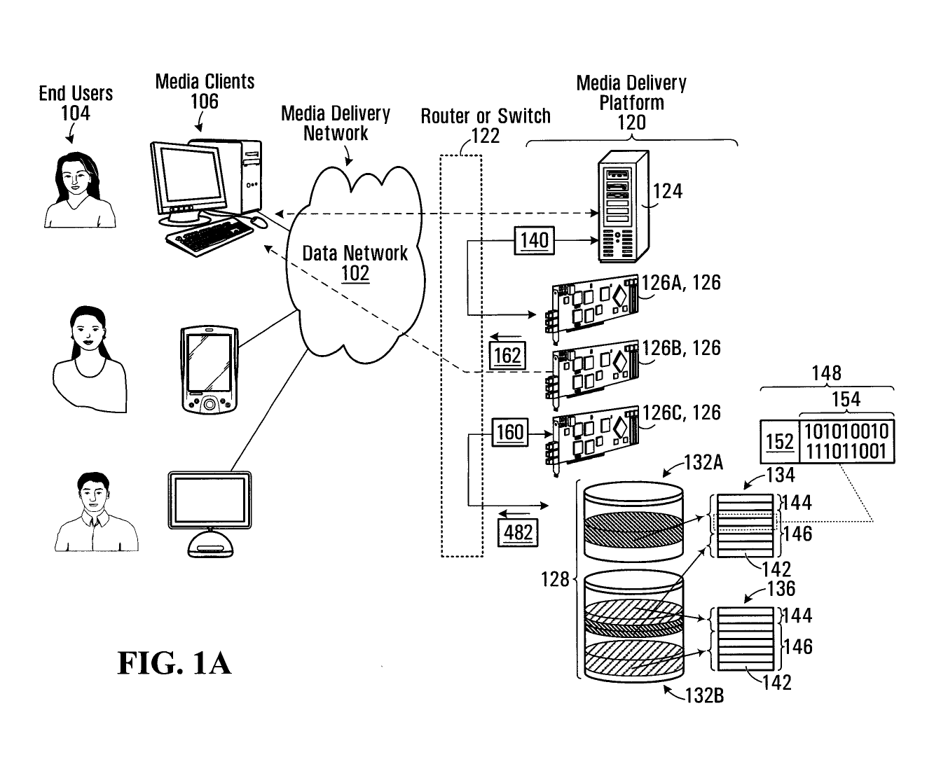

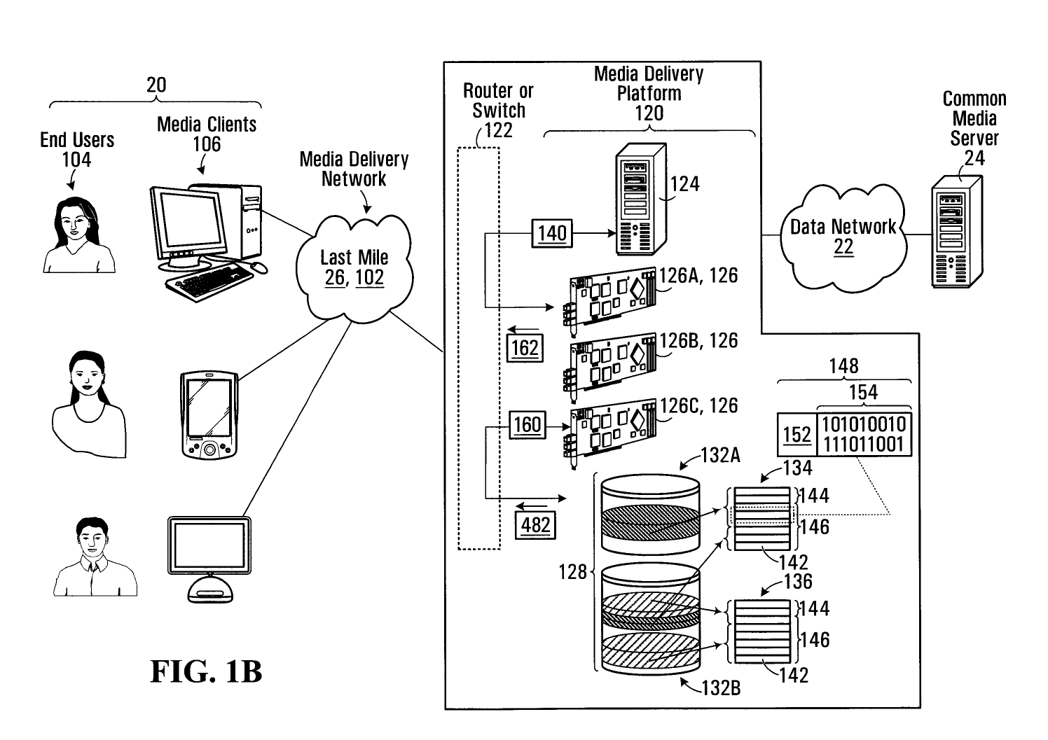

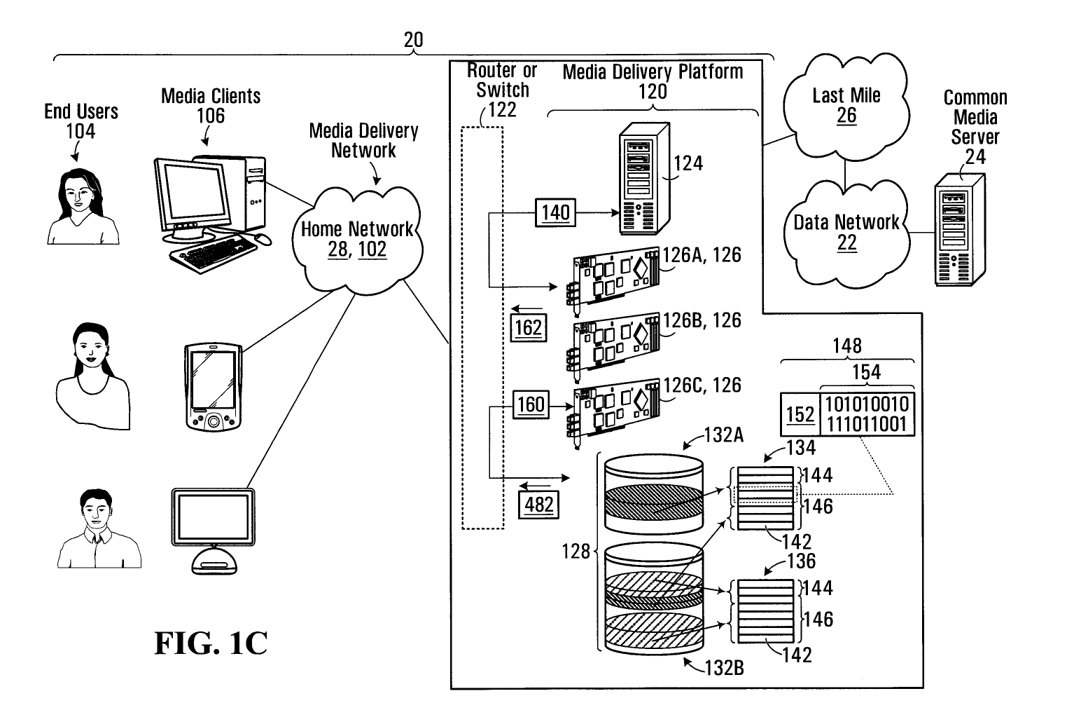

Reference is made to FIGS. 1A, 1B and 1C, which show variants of an architecture for the delivery of media to a plurality of end users 104, in accordance with non-limiting embodiments of the present invention. By “media” is meant one or more data elements (e.g., packets, files, datagrams) that encode text, graphics, audio, video or any combination thereof, for reproduction (e.g., playback) on a media engine. The end users 104 may employ respective media clients 106 for the purpose of enjoying the text, graphics, audio and/or video encoded by the aforesaid media.

The architectures of FIGS. 1A, 1B and 1C include a media delivery platform 120 that comprises a media control server 124, one or more data path devices 126 and a media storage entity 128 operatively coupled to the one or more data path devices 126. The media control server 124, data path devices 126 and media storage entity 128 can be interconnected via a router or switch 122 so as to form a private network. The media delivery platform 120 outputs media destined for the media clients 106 over a network 102 hereinafter referred to generically as a media delivery network 102 because media is delivered to the media clients 106 over this network.

In the specific non-limiting embodiment of FIG. 1A, the media delivery network 102 includes or traverses a data network 22 such as, without limitation, the Internet. In the specific non-limiting embodiment of FIG. 1B, the media delivery network 102 includes a “last mile” access network 26, which is situated between the data network 22 and a customer premises 20 where a particular one of the media clients 106 is located. In the specific non-limiting embodiment of FIG. 1C, the media delivery network 102 includes a home network 28, which is situated at the customer premises 20. In each case, it should be appreciated that the private network interconnecting the various components of the media delivery platform can be physically separate from, or part of, the media delivery network 102.

A particular one of the media clients 106 that is associated with a particular one of the end users 104 may run a variety of software applications that may include a connection engine 108 and a media engine 110. The connection engine 108 running on the particular one of the media clients 106 may implement a graphical user interface that allows the particular one of the end users 104 to connect with a particular server identified by the particular one of the end users 104.

In various non-limiting embodiments, the connection engine 108 can be a browsing engine. A non-limiting example of a browsing engine that may be implemented on a computing apparatus (such as a PC, laptop, tablet PC, etc.) is a web browser such as Microsoft Internet Explorer. Other types of browsing engines may be implemented on computing apparatuses or on other types of media clients such as mobile phones, handheld personal digital assistants and television set-top boxes, for example. The media engine 110 running on the particular one of the media clients 106 implements a graphical user interface that allows the particular one of the end users 104 to effect local control of media obtained from servers (including the particular server) reached using the browsing engine. A non-limiting example of the media engine 110 that may be implemented on a computing apparatus (such as a PC, laptop, tablet PC, etc.) is Microsoft Media Player. Other types of media engines may be implemented on computing apparatuses or on other types of media clients such as mobile phones, handheld personal digital assistants or television set-top boxes, for example.

One of the main functions of the media engine 110 is to reproduce (e.g. play back) media received from servers (including the particular server) reached using the connection engine 108. It should be appreciated that different media engines may require the media to arrive from the servers (including the particular server) in a certain encoding format or set of encoding formats, such as MPEG-2, MPEG-4, etc. Where in the case of the particular server the media is available to be received in a plurality of encoding formats, the media engine 110 may provide the particular one of the end users 104 with an additional level of control, which is to select the encoding format that the media arriving from the particular server is to have.

Turning now to the media delivery platform 120, it will be appreciated that the media control server 124 is reachable by the media clients 106 over the media delivery network 102. For example, the media control server 124 can be associated with an address or other identifier that is recognized by the media delivery network 102 such that when this address or identifier is provided by a particular one of the media clients 106, the latter will connect to the media control server 124, thereby establishing a “media control session” 130 between the particular one of the media clients 106 and the media control server 124.

Additionally, the media control server 124 is connected to the one or more data path devices 126 over a control path 140. It should be understood that although three (3) data path devices 126A, 126B, 126C are illustrated by way of non-limiting example, there is no particular limit on the number of data path devices. Also, when more than one data path device is provided, these can be arranged as a bank of data path devices 126 that are stand-alone in that they may be independently accessible and do not have the need to exchange data amongst themselves.

In addition, the media control server 124 and one or more data path devices 126 may be separate components, although it is also within the scope of the present invention for the media control server 124 to be integrated with the one or more data path devices 126 within the same hardware device, chassis or even on the same chip.

The media storage entity 128 is where media that can be potentially sent to the end users 104 is stored. Depending on the embodiment of the media delivery platform, the media storage entity 128 may comprise a storage area network (SAN) consisting of multiple storage devices 132A, 132B such as disk arrays, tape libraries, optical jukeboxes and a DRAM-based SAN, although implementations other than a SAN are possible and are within the scope of the present invention.

In the scenario where one or more data path devices 126 and the media storage entity 128 are located on the client-side edge of the data network 22 (as in FIGS. 1B and 1C), and by way of example where the media comprises movies, the media delivery platform 120 can be designed to store a cache of the most viewed movies (as opposed to all available movies). The cache can be populated by a “recording” function that connects the one or more data path devices 126 and the media storage entity 128 with a common media server 24 reachable via the data network 22.

The media that can be potentially sent to the end users 104 may be organized into “media objects” 134, 136 that are each stored either on one of the storage devices 132A, 132B at one or more respective memory blocks, or distributed among multiple ones of the storage devices 132A, 132B. Where the media that can be potentially sent to the end users 104 consists of movies, each of the media objects 134, 136 in the media storage entity 128 may be associated with a movie (either the same movie or different movies) and may be stored across one or more storage devices 132A, 132B at one or more respective memory blocks. It should be noted that for the media control server 124 stores or has access to a master table or map, which stores information on the path leading to the various media objects 134, 136, i.e., information on where to find the media objects 134, 136 within the media storage entity 128.

In a non-limiting embodiment, the media objects 134, 136 can be files that are ready to be played back by a particular media engine (such as the media engine 110). Each movie can be associated with multiple ones of the files 134, 136, with each such file corresponding to a different encoding format. Where a movie is initially purchased by an operator of the media delivery platform 120 in only one format, such operator may utilize an off-line media file converter (not shown) to effect conversion of the movie into plural encoding formats (and storage as separate files) for eventual delivery to the media clients 106. Video scaling can also performed by the off-line media file converter such that multiple ones of the files 134, 136 are created, with each such file corresponding to a different video resolution. Alternatively, where the media delivery platform 120 is located on the client-side edge of the data network 22 (see FIGS. 1B and 1C), multiple versions may be requested over the Internet from a common media server 24 and cached by the media delivery platform 120 for eventual delivery to the media clients 106 over the media delivery network 102.

Moreover, in order to improve the seek time when performing “rewind” and “fast-forward” operations, the end of each of the files 134, 136 may contain a “time reference mapping table” 142 whereby a media data location is stored for each time interval of video streaming. In order to have acceptable accuracy without inflating the media file, the time interval can be set at one minute, for example.

Each of the files 134, 136 can also contain a header 144 and a body 146. The header 144 can include general information regarding the respective one of the files 134, 136, such as file type, file version, header size, offset to the time reference mapping table 142, video codec, frame rate, bit rate, image width, image height, as well as specific information about the codec (e.g., H264 profile, level, etc.), to name a few non-limiting possibilities.

In addition to the reference mapping table 142, the body 146 can be in the form of include UDP (user datagram protocol) packets containing one or more RTP (real-time transport protocol) packets (hereinafter UDP/RTP packets) 148, each of the UDP/RTP packets 148 including a version of an RTP packet header 152 and an RTP packet body 154. The RTP packet header 152 may indicate, among other information, the size of the respective one of the UDP/RTP packets 148, a timestamp and a sequence number, while the RTP packet body 154 includes the encoded media associated with the respective one of the files 134, 136. Of course, formats other than RTP will become apparent to those of ordinary skill without departing from the scope of the present invention. Specifically, I-TDM (Internal TDM) packets is a non-limiting alternative that may be suitable for a mobile phone environment.

Returning now to the media control session 130, communication between the media client 106 and the media control server 124 may occur, in a non-limiting embodiment, using a control protocol such as RTSP, which was developed by the IETF and published in 1998 as RFC 2326. This standard protocol allows the end user 104 to remotely control “media streaming” via the media engine 110 and issue user commands including, but not limited to, the following:

| User | |
|---|---|
| command | Description |
| DESCRIBE | Used to request the types of streams supported at a |
| | specific RTSP uniform resource locator (URL). |
| SETUP | Used to request a new data session. This user |
| | command's metadata includes parameters for the data |
| | session, such as the identity of a file. |
| PLAY | Used to request playback from the beginning or a |
| | specified location in the file. |
| PAUSE | Used to stop playback until a new PLAY user command |
| | is issued. |
| TEARDOWN | Used to request the termination of the data session. |
| | Upon reception, media playback is stopped and the |
| | data session is terminated. |

Thus, a particular one of the end users 104 associated with a particular one of the media clients 106 can express a desire to control the delivery of media from the media delivery platform 120 by sending user commands over the media control session 130. How this results in the delivery of media to the particular one of the media clients 106 is detailed below. Generally speaking, however, the media control server 124 communicates over a control path 140 with a particular one of the data path devices 126 to inform the latter of the user commands. The particular one of the data path devices 126 then communicates with the media storage entity 128 over a data/control path 160 to retrieve stored media data therefrom. The particular one of the data path devices 126 then creates a “data session” 150 with the particular one of the media clients 106 without involving the media control server 124. This frees the media control server 124 from having to perform various processing and other tasks on the UDP/RTP packets 148 as they travel from the media storage entity 128 to the particular one of the media clients 106. As a result, the capacity of the media delivery platform 120 can be increased so as to handle greater numbers of media clients 106 by simply adding more data path devices 126 without requiring an enhancement or upgrade to the media control server 124, thus resulting in a more scalable and cost effective solution for the delivery of media over the media delivery network 102.

The control path 140 between the media control server 124 and the data path devices 126 can be established in a variety of ways. Consider an embodiment where the media control server 124 is housed in a computing apparatus that also houses the data path devices 126 implemented as circuit boards connected via a data bus (e.g., PCI, cPCI or ATCA-Ethernet bus). In this case, the control path 140 between the media control server 124 and the data path devices 126 is established by the exchange of information over such data bus. In another embodiment, the data path devices 126 can be stand-alone devices that are reachable from the media control server 124 by a network connection (e.g., Ethernet), which may involve the router or switch 122. In this case, the control path 140 between the media control server 124 and the data path devices 126 is established by the exchange of frames or packets over the network connection. In the case where a shared Ethernet medium is used to establish the control path 140, techniques such as virtual local area networks (e.g., IEEE 802.3q) can be used to ensure priority of the control path packets or frames over other packets or frames sharing the Ethernet medium. An IP connection could also be used for the control path 140.

For its part, the data/control path 160 can also be established in a variety of ways. In one non-limiting embodiment, the data/control path 160 can be an iSCSI path whereby the data path devices 126 communicate with the media storage entity 128 over using the iSCSI protocol. For example, in the case of the data session 150 created between a particular one of the data path devices 126 and a particular one of the media clients 106, an Internet-style connection is established between the particular one of the data path devices 126 and a particular one of the storage devices 132A, 132B to effect the release of a burst of iSCSI reply packets containing complete or fragmented UDP/RTP packets 482 from the particular one of the storage devices 132A, 132B. The complete or/and fragmented UDP/RTP packets 482 within the iSCSI reply packets are received at the particular one of the data path devices 126, reassembled and encapsulated into IP/UDP/RTP packets 162 by the particular one of the data path devices 126. The resultant IP/UDP/RTP packets 162 are then sent out (possibly over the media delivery network 102 via the router or switch 122) to various ones of the media clients 106 with which data sessions may have been established.

Further details regarding the establishment of the control path 140 and the data/control path are provided by the below description of the media control server 124 and the data path devices 126.

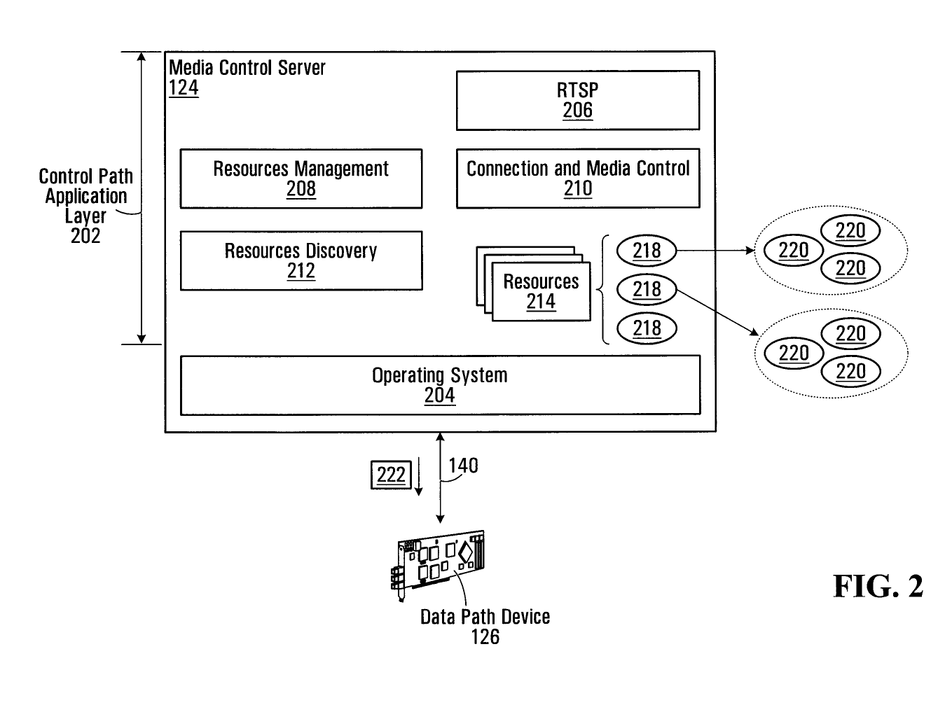

In particular, the media control server 124 and the data path devices 126 each comprise functional components that are involved in establishment of, and communication over, the control path 140. The relevant components of the media control server 124 are now described in greater detail with reference to FIG. 2. Specifically, the media control server 124 implements a control path application layer 202 residing over an operating system 204 such as Windows, MacOS or Linux (to name a few non-limiting possibilities). The control path application layer 202 comprises an RTSP component 206, a resources management component 208, a connection and media control component 210, a resources discovery component 212 and a resources component 214. Each of these components 206, 208, 210, 212, 214 may be implemented in software, hardware, firmware or a combination thereof.

The RTSP component 206 exposes the RTSP connection and media control protocol, which allows the end users 104 to remotely control media streaming by issuing the previously described user commands over the media control session 130.

The resources discovery component 212 effects new resources discovery by listening to special messages over the control path 140 coming from new data path devices added to the media delivery platform 120. A new data path device may be added to the media delivery platform 120 in a number of ways, such as by plugging it into a slot of a chassis, for example. Upon discovery of the new data path device, the resources discovery component 212 reports to the resources management component 208 information about the new data path device such as its identity and capabilities.

The resources management component 208 allows the control path application layer 202 to manage resources (namely, the data path devices 126). More specifically, the resources management component 208 allows the control path application layer 202 to:
make groups of primary and backup resources (e.g., individual ones of the data path devices 126 or portions thereof) for high-availability support;
limit resource utilization to a desired maximum percentage (e.g., 50%);
handle alarms coming from the data path devices 126;
query data path devices for QoS metrics;
handle load-balancing among data path devices 126;
shutdown or reset individual data path devices 126; and
update software on the data path devices 126 automatically upon new discovery, shutdown/reset, or on-request at a later time by an operator.

Also, in case a previously discovered data path device has not communicated with the media control server 124 for a long time (e.g., exceeding a pre-determined threshold number of seconds or minutes), the resources management component 208 can use a “ping-pong” message technique to make sure that data path device in question is still “alive”.

The resources component 214 manages a set of parent objects 218 and resource connection objects 220. Specifically, discovery of a new data path device by the resources discovery component 212 causes the creation of a parent object 218 for the new data path device, which then allows the creation of individual resource connection objects 220, one for each of the data sessions that may need to be established. Specifically, it should be appreciated that a particular data session carries media from a particular one of the media objects 134, 136 to a particular one of the media clients 106 using the resources of a particular one of the data path devices 126. Thus, each of the data sessions (and hence each of the resource connection objects 220) can be associated to a particular media object, media client and data path device.

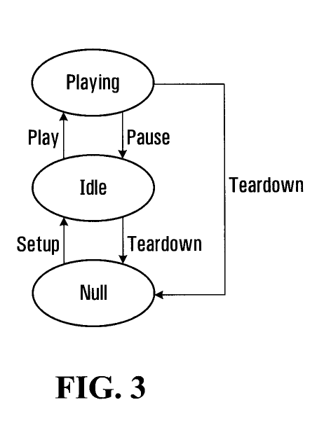

At a given moment in time, each of the data sessions (and hence each of the resource connection objects 220) can be said to be in one of several “states” in accordance with a state machine, an example of which is shown in FIG. 3. The states include a PLAYING state (during which streaming takes place), an IDLE state and a NULL state. It will be noted that the state machine defines how the state of an individual data session (or resource connection object) may change over time.

For its part, the connection and media control component 210 manages the resource connection objects 220 by implementing asynchronous “methods” based on the user commands detected by the RTSP component 206 as being received via the media control session 130. Execution of such methods may result in state changes to the resource connection objects 220. Specifically, the resources component 214 is responsible for responding to the methods implemented by the connection and media control component 210, by changing the states of individual resource connection objects 220 and sending appropriate connection and media control commands 222 to the data path devices 126.

The following table provides non-limiting examples of methods that can be implemented by the connection and media control component 210, as well as the connection and media control commands 222 they cause to be issued by the resources component 214. It should be appreciated that the methods apply to an individual one of the resource connection objects 220 associated with a particular data session, which carries media from a particular one of the media objects 134, 136 to a particular one of the media clients 106 using the resources of a particular one of the data path devices 126.

| | | Connection and |
|---|---|---|
| | | media control |
| Method | Description | command 222 |
| Session.Setup | Used to specify data transport information for the | SETUP |
| | particular data session, including a protocol (e.g., | |
| | RTP/AVP/UDP), a mode (e.g., unicast or multicast), an | |
| | IP address and ports used by the end user 104 of the | |
| | particular one of the media clients 106 for RTP and | |
| | RTCP. If successful, this method returns the ports | |
| | used by the particular one of the data path devices 126 | |
| | for RTP and RTCP. In addition, the state of the | |
| | individual one of the resource connection objects 220 | |
| | changes from NULL to IDLE. | |
| Session.Teardown | Used to terminate the particular data session. If | TEARDOWN |
| | successful, this method causes the individual one of | |
| | the resource connection objects 220 to go back into the | |
| | NULL state from any previous state. | |
| Session.Play | Used to start media streaming. Associated metadata | PLAY |
| | for this method contains a path to the particular one of | |
| | the media objects 134, 136, as well as a beginning time | |
| | and end time for the streaming; else it assumes the | |
| | entire media object is to be played from the beginning | |
| | or from the last location where the streaming had been | |
| | suspended. If successful, this method causes the state | |
| | of the individual one of the resource connection objects | |
| | 220 to change from IDLE to PLAYING. | |
| Session.Pause | Used to suspend active media streaming. If | PAUSE |
| | successful, this method causes the actual location of | |
| | streaming to be stored and causes the state of the | |
| | individual one of the resource connection objects 220 | |
| | to change to IDLE unless it is already in that state. | |

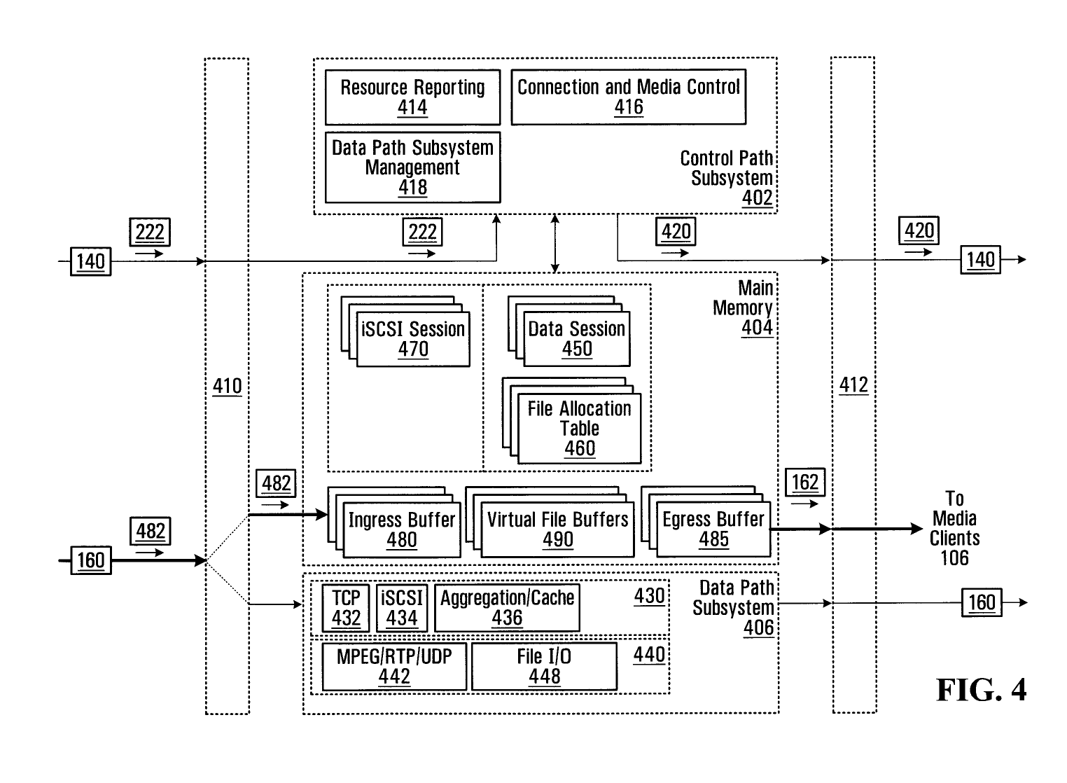

Reference is now made to FIG. 4, which conceptually shows the structure of any of the data path devices 126 (e.g., data path device 126A). Data path device 126A comprises an input interface 410 and an output interface 412 that connect data path device 126A to the media control server 124, to the media storage entity 128 and to a media client via the router or switch 122. Data path device 126A comprises a control path subsystem 402, a main memory 404 and a data path subsystem 406. The main memory 404, which will be described in further detail later on, comprises a set of control structures 408 that store information used by the data path subsystem 406 in establishing data sessions with the media clients 106. The control path subsystem 402 communicates with the media control server 124 over the control path 140. One of its duties is to update the aforesaid control structures 408 in the main memory 404.

The input interface 410 handles incoming data, which can take on one of at least three forms, and sends it to the appropriate entity, namely the control path subsystem 402, the main memory 404 or the data path subsystem 406. Firstly, incoming data may be received in the form of iSCSI reply packets containing UDP/RTP packets 482 with multiple RTP packets (and possibly fragments of RTP packets at the beginning and end of the iSCSI reply packets) from the memory storage entity 128 over the data/control path 160. Such incoming data is sent by the input interface 410 directly to the main memory 404. Secondly, the incoming data may contain iSCSI packets that do not contain UDP/RTP packets but are nevertheless received from the memory storage entity 128 over the data/control path 160. Such incoming data is sent by the input interface 410 to the data path subsystem 406. Thirdly, the incoming data may comprise media control commands 222 received from the media control server 124 over the control path 140. Such incoming data is sent by the input interface 410 to the control path subsystem 402.

The output interface 412 handles transmitted data, which can take on one of at least three forms. Firstly, the transmitted data may contain IP packets 162 (containing IP-encapsulated UDP/RTP packets) issued by the main memory 404, which are destined for a particular one of the media clients 106 over a data session. Such transmitted data is released by the output interface 412 towards the media client via the router or switch 122. Secondly, the transmitted data may contain iSCSI packets (such as iSCSI request packets), which are destined for the memory storage entity 128. Such transmitted data is placed by the output interface 412 onto the data/control path 160. Thirdly, the transmitted data may contain acknowledgements and other control information destined for the media control server 124. Such transmitted data is sent by the output interface 412 on the control path 140.

The control path subsystem 402 comprises a resource reporting component 414, a connection and media control component 416 and a data path subsystem management component 418. Each of the components 414, 416, 418 may be implemented in software, hardware, firmware or a combination thereof.

The resource reporting component 414 serves to make the media control server 124 aware of the presence of data path device 126A. Thus, the resource reporting component 414 is configured to transmit an announcement packet 420 to the media control server 124 along the control path 140 at regular intervals. The announcement packet 420 may be a broadcast Ethernet packet, for example. The announcement packet 420 may comprise metadata, which may specify the resource capabilities of data path device 126A, for example. It will be appreciated that the announcement packet 420 is handled by the resource discovery component 212 of the media control server 124. The resource reporting component 414 of data path device 126A is also responsible for alarm reporting, replying to QoS queries, updating the device's flash programs, as well as handling shutdown and “soft reset”. The resource reporting component 414 is also responsible for replying to “ping-pong” packets received from the media control server 124 along the control path 140.

As stated earlier, the main memory 404 comprises the set of control structures 408 that store information used by the data path subsystem 406 of data path device 126A in establishing the data sessions. With continued reference therefore to FIG. 4, the control structures 408 include a data session control structure 450, a file allocation table control structure 460 and an iSCSI session control structure 470.

The data session control structure 450 contains information that relates to individual data sessions and their current states (i.e., PLAYING, IDLE or NULL). For a given data session involving a particular one of the media clients 106, the data session control structure 450 comprises a corresponding entry that includes the IP address and RTP port utilized by the particular one of the media clients 106, a local port number, as well as a reference to the entry in the file allocation table control structure 460 (see below) when the session is in the PLAYING state.

The file allocation table control structure 460 includes mapping information that allows the retrieval, from the media storage entity 128, of UDP/RTP packets associated with the media objects 134, 136. The file allocation table control structure 460 comprises an entry for each data session that is in the PLAYING state, in which case this entry is linked to the corresponding entry in the data session control structure 450. This entry is updated when the end user requests playback from a different location within the media object in question, and it is removed when the data session has been torn down.

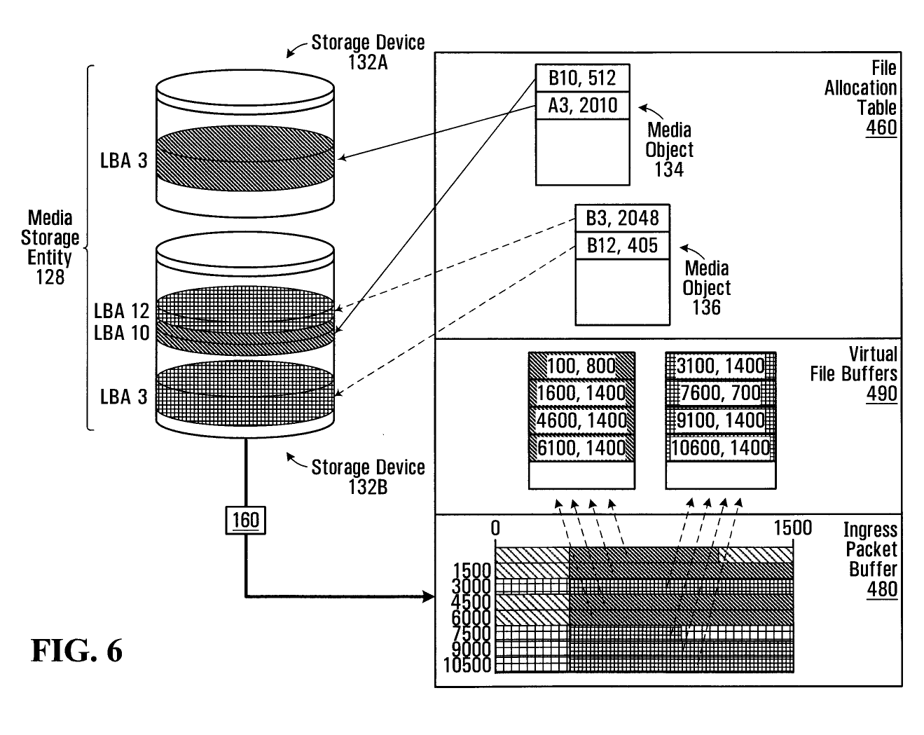

With additional reference to FIG. 6, the mapping information included in the file allocation table control structure 460 for a given data session involving a particular one of the media clients 106 includes iSCSI target details needed to create an iSCSI session over the data/control path 160 to retrieve blocks of data (see below), and file addressing details for each such block of data containing the UDP/RTP packets that are to be streamed to the particular one of the media clients 106. Since data path devices other than data path device 126A may desire to access the contents of the media object in question at the same time, a distributed file system allowing file sharing can be used on the iSCSI target (i.e., storage devices 132A, 132B); for example, the media control server 124 may change the properties of the media objects 134, 136 to “read-only” during playback.

The iSCSI session control structure 470 is somewhat different than the two previously described control structures (namely, the data session control structure 450 and the file allocation table control structure 460) in that it is not managed by the control path subsystem 402. Instead, they are managed by an iSCSI component of the data path subsystem 406 of data path device 126A (see later) to keep certain additional information required to create iSCSI sessions and to handle iSCSI request packets and reply packets. The iSCSI session control structures 470 also include references to entries in the file allocation table control structure 460.

Returning now to the description of the control path subsystem 402 of data path device 126A, the connection and media control component 416 handles the various connection and media control commands 222 (e.g., SETUP, TEARDOWN, PLAY, RECORD and PAUSE) received from the resources component 214 by acknowledging the received command and updating the appropriate control structures in the main memory 404 (namely, the data session control structure 450 and the file allocation table control structure 460).

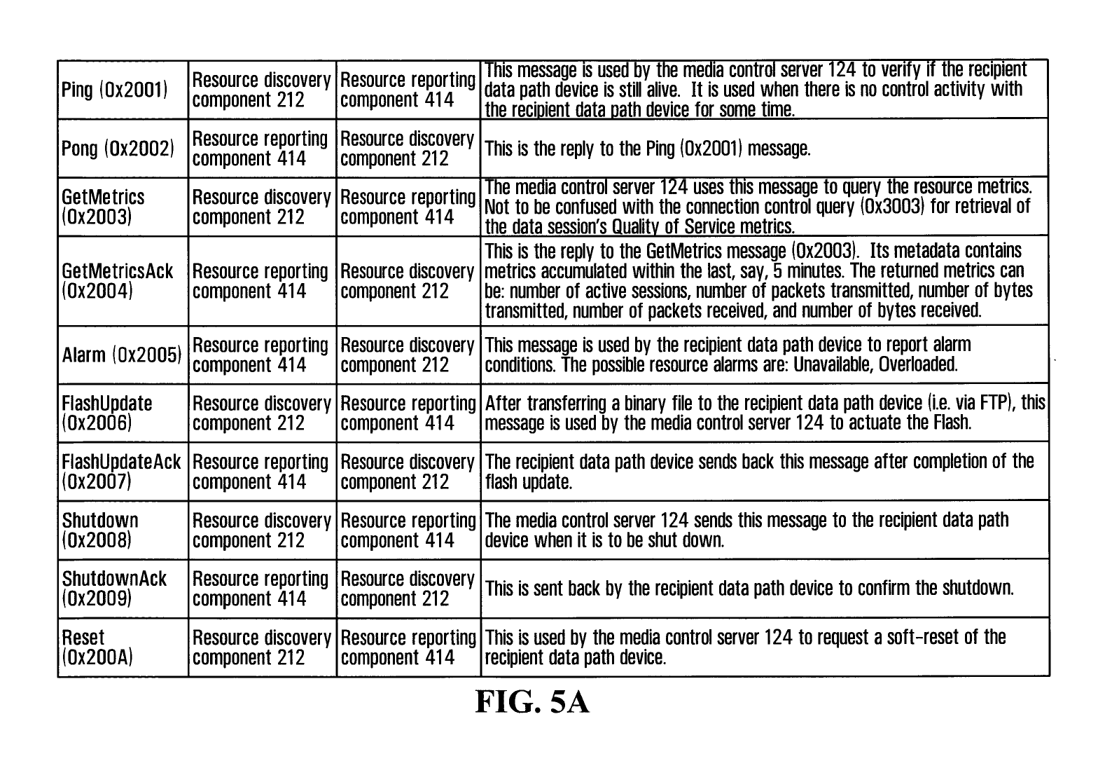

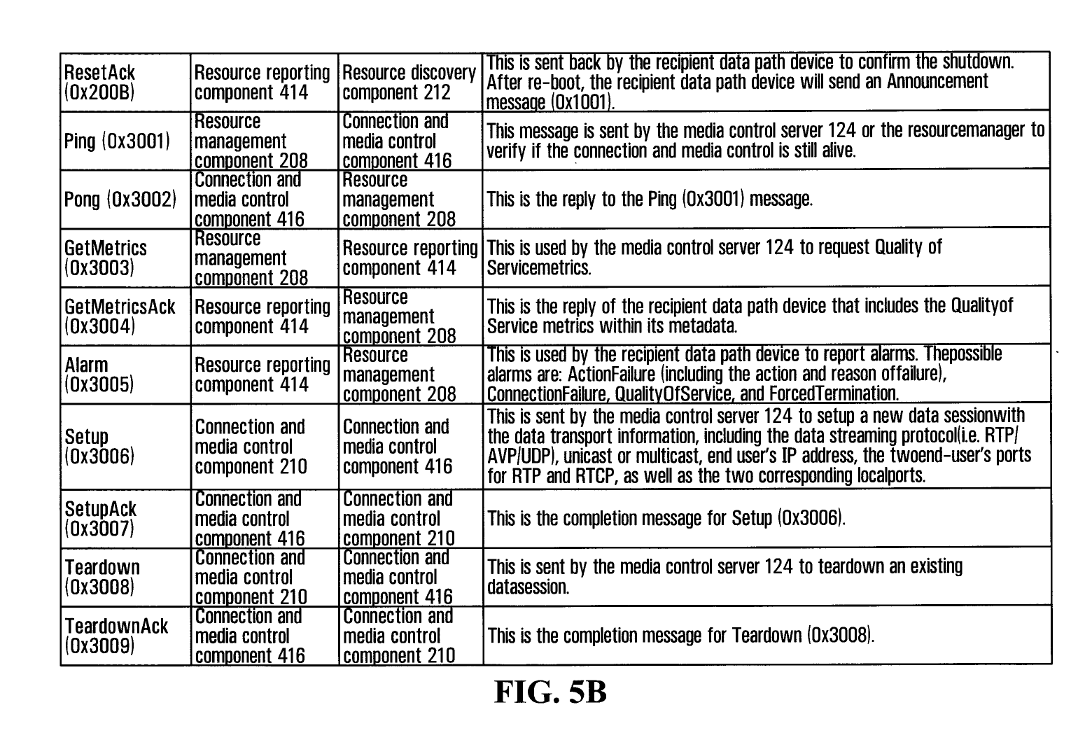

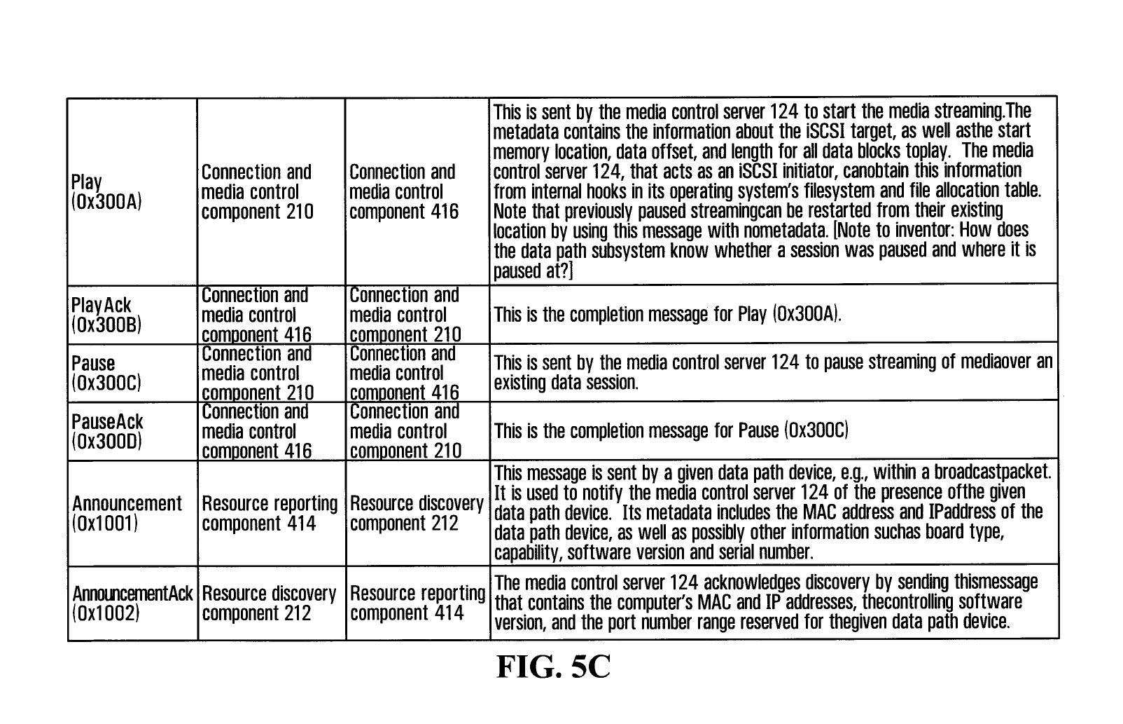

For further information, FIG. 5 provides a summary of certain messages that can be exchanged between the media control server 124 and the control path subsystem 402 of data path device 126A over the control path 140, including an indication of the source and destination of each message, in accordance with a non-limiting example of the present invention.

With continued reference to FIG. 4, the main memory 404 comprises buffer structures for temporarily storing the iSCSI reply packets containing complete and fragmented UDP/RTP packets 482 received from the media storage entity 128, as well as IP/UDP/RTP packets to be transmitted to the media clients 106. These buffer structures comprise an ingress buffer 480 and an egress buffer 485. The ingress buffer 480 is used for storing the incoming iSCSI reply packets containing UDP/RTP packets 482 with complete and fragmented RTP packets received from the media storage entity 128, while the egress buffer 485 is used for storing the outgoing IP/UDP/RTP packets 162 before transmission to the various media clients 106 with which data sessions have been established. In fact, the egress buffer can be a virtual buffer, thus providing a “lazy” copying mechanism that avoids all internal memory copy operations.

As shown in FIG. 6, the main memory 404 also comprises “virtual file buffers” 490 that make reference to how data is arranged in the ingress buffer 480 such that it creates a virtual file data cache. Specifically, each time a media object is to be retrieved from the media storage entity 128 (e.g., in connection with a given data session), there results the creation of a new virtual file buffer for that media object. The media object in question is retrieved piecewise and the individual portions are placed into the ingress buffer 480 in various blocks of locations, interleaved with other blocks of locations that store other media objects in connection with other data sessions. The blocks of locations pertaining to the media object in question are indexed by the virtual file buffer that was created for the media object in question. As data is read out of the ingress buffer 480, the virtual file buffer is updated to always indicate where in the ingress buffer one can find the media object in question. Thus, by referencing only those portions of the ingress buffer as specified by the virtual file buffer, one has the impression of accessing a contiguous block of data corresponding to the media object in question. However, one will notice that the virtual file data cache implemented by the virtual file buffer contains only a part of a media object, in contrast to whole media objects stored in the media storage entity 128.

Of course, it should be appreciated that the main memory 404 may comprise a mix of different types of memory (e.g., SRAM, SDRAM, etc.), depending on operational requirements.

Returning now to the control path subsystem 402 in FIG. 4, the data path subsystem management component 418 handles management and monitoring of the data path subsystem 406. Specifically, the data path subsystem management component is responsible for communication with the real-time entities in the data path subsystem 406, for example: stopping or starting functional blocks, logging and error condition management. Further details regarding the data path subsystem 406 are provided below.

Specifically, the data path subsystem 406 comprises suitable hardware, circuitry and/or software for continually implementing real-time streaming cycles. During each real-time streaming cycle, the data path subsystem 406:
releases expired IP packets 162 in the egress buffer 485 towards the media clients 106;
encapsulates UDP/RTP packets 482 in the ingress buffer 480 into IP packets 162 that are stored in the egress buffer 485 to replace the released expired IP packets 162; and
replenish the ingress buffer 480 with new iSCSI reply packets containing UDP/RTP packets with complete and fragmented RTP packets 482 obtained from the memory storage entity 128.

In order to effect the above functions, the data path subsystem implements a data retrieval entity 430 which cooperates with a data streaming entity 440.

The data retrieval entity 430 comprises a TCP component 432, an iSCSI component 434 and an aggregation and cache component 440. Each of these components 432, 434, 436 may be implemented in software, hardware, firmware or a combination thereof.

The TCP component 432 implements a TCP layer in order to provide compatibility with certain standard storage targets. Implementations are contemplated that will support TCP connection establishment, ordered data transfer, retransmission of lost packets, discarding of duplicate packets, error-free data transfer, and RFC 2581 congestion control. Since the iSCSI targets (e.g., the storage devices 132A, 132B) are expected to be on a reliable local network (e.g., a private network), it can be assumed that processing overhead associated to TCP will not be significant, thereby allowing maximal utilization of the data/control path 160 for data transfer.

The iSCSI component 444 acts as an initiator when a given data session is in the PLAYING state. If an iSCSI session does not yet exist for the given data session, the iSCSI component establishes a new iSCSI session with the particular storage device where the UDP/RTP packets for the given data session are stored. The iSCSI layer also allows the encapsulation and decapsulation of iSCSI request packets and reply packets. Optionally, the iSCSI session previously established by the media control server 124 can be re-used. In such a case, the required information regarding the storage target session identification is sent to the data path device at the establishment of the data session (SETUP).

The aggregation and cache component 446 sends read requests to the media storage entity 128 over the data/control path 160 based on the content of the file allocation table control structure 460. Specifically, for a given data session, the aggregation and cache component 446 attempts to fill the ingress buffer 480 until the level of the particular one of the virtual file buffers 490 associated with the given data session reaches a “high watermark”, and then re-starts the filling process as soon as the level of the particular one of the virtual file buffers 490 reaches a “low watermark”. Note that instead of actually copying the data when it receives the iSCSI reply packets, the aggregation and cache component 446 only adds data references in the particular one of the virtual file buffers 490, similarly to a linked list. Thus, references are kept in the particular one of the virtual file buffers 490 to the portions of the ingress buffer 480 containing the UDP/RTP packets for the given data session.

For its part, the data streaming entity 440 comprises a file I/O component 444 and an MPEG/RTP/UDP component 442. Either or both of these components 442, 444 may be implemented in software, hardware, firmware or a combination thereof.

Specifically, the file I/O component 444 implements algorithms required to effect transfer data from the ingress buffer 480 to the egress buffer 485 by following the references stored in the virtual file buffers 490 corresponding to various data sessions. Streaming of data for a given session starts when the level of the particular one of the virtual file buffer levels 490 corresponding to the given data session reaches the previously described high watermark. Streaming calls for scheduling of data frames, which is done periodically every, say, 10 milliseconds, whereby only the UDP/RTP packets “stored” in the particular one of the virtual file buffers 490 that have an elapsed timestamp are transferred to the egress buffer 485. This process is performed every 10 milliseconds for each data session in the PLAYING state. Packets transferred to the egress buffer 485 are given the IP address of the corresponding one of the media clients 106 with which the given data session has been established. It is also noted that the references stored in the particular one of the virtual file buffers 490 are update to reflect the fact that UDP/RTP packets have been read from the ingress buffer 480, which will trigger the data retrieval entity 430 to retrieve new UDP/RTP packets from the media storage entity 128.

The MPEG/RTP/UDP component 442 optionally provides utility methods for extracting or updating protocol header information, including retrieval of I-Frame flags, or updates to timestamps and sequence numbers which are calculated based on offsets, so as to ensure real-time streaming according to the playback timing at the corresponding one of the media clients 106, despite events such as pause, resume, rewind, fast-forward, and advertisement insertion. Also, the MPEG/RTP/UDP component 442 inserts RTCP packets, which are control packets sent at specific time intervals. These packets ensure that the RTP connections are alive, in addition to provide the end-user with Quality-of-Service (QoS) metrics, as well as information regarding the synchronization of multiple channels (i.e. audio and video). For each RTP connection, there is an associated RTCP connection. Usually, the RTCP connection uses the port of the RTP connection +1. The RTCP packets list the SSRCs which is a field in the RTP packet header that uniquely identifies the source of the media stream. Thus, the SSRCs that are inside the audio and video streams (i.e., in the headers of the RTP packets for those streams) are listed inside the RTCP control packets, along with the time references of each, so that offsets can be calculated between the streams which indicate to the media engine 110 how to play audio and video frames in a synchronous fashion.

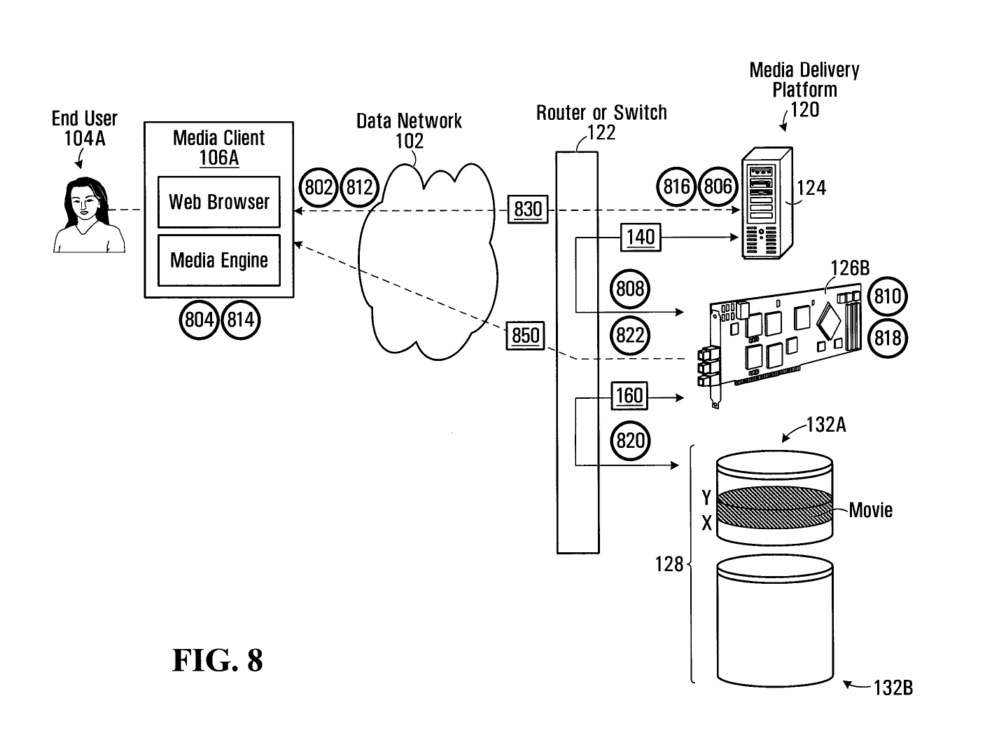

With reference to FIG. 8, consider an operational example, whereby an end user 104A utilizes a media client 106A that has access to the media delivery network 102, which in this example traverses the data network 22. Media client 106A runs a connection engine implemented as a web browser, and also runs a media engine. Consider now the following sequence of events:
802: End user 104A browses using the web browser and the media engine of media client 106A and reaches the media control server 124 over the media delivery network 102. After end user 104A identifies a particular movie of interest, a media control session 830 is established between media client 106A and the media control server 124.
804: Media client 106A sends a SETUP user command over the media control session 830, identifying the particular movie.
806: The connection and media control component 210 in the media control server 124 determines which data path device will be responsible for the eventual data session. Assume that the responsible entity is data path device 126B. The connection and media control component 210 creates a particular resource connection object as a child of the parent object associated with data path device 126B.
808: The connection and media control component 210 implements the Session.Setup method. This results in the transmission of a SETUP connection and media control command to data path device 126B over the control path 140 (see FIG. 1A, 1B or 1C for various non-limiting alternatives of the control path 140). In this way, data path device 126B is informed of the IP address and ports being used by media client 106A as well as other information. Also, the connection and media control component 210 changes the state of the particular resource connection object from NULL to IDLE.
810: In response to the SETUP media connection and media control command, the connection and media control component 416 in the control path subsystem 402 of data path device 126B returns the ports used by data path device 126B and causes the creation of an entry for an eventual data session in the data session control structure 450. The connection and media control component 416 returns the port information to the media control server 124 over the control path 140.
812: The media control server 124 sends the port information over the media control session 830 to media client 106A for future use.
814: End user 104A chooses to play back the particular movie. Media client 106A sends a PLAY user command over the media control session 830.
816: The connection and media control component 210 implements the Session.Play method, which involves identifying the path to the particular movie within the media storage entity 128. Assume that the particular movie is stored at between memory locations X and Y on storage device 132A. This information is sent to data path device 126B in the form of the PLAY connection and media control command. The state of the particular resource connection object is changed to PLAYING. The media control server 124 acknowledges the PLAY user command over the media control session 830 to media client 106A.
818: In response to the PLAY media connection and media control command, the connection and media control component 416 in the control path subsystem 402 of data path device 126B causes the creation of an entry in the file allocation table control structure 460 in the main memory 404, and links it together with the entry in the data session control structure 450 previously created at step 810.

Meanwhile, data path device 126B has been performing its real-time streaming cycle, which does not result in much activity until the control structures 450, 460 are updated by the control path subsystem 402. Thus, the aggregation and cache component 436 of the data retrieval entity 430 in the data path subsystem 406 of data path device 126B communicates with storage device 132A to begin piecewise retrieval of UDP/RTP packets (event 820), according to the mapping information in the file allocation table control structure 450 for the given data session, in order to “fill” the corresponding one of the virtual file buffers 490 until the high watermark. Data path device 126B starts again to request more data when the level of the corresponding one of the virtual file buffers 490 reaches the low watermark. The high and low watermarks are measured relative to the current read position in the corresponding one of the virtual file buffers 490. As UDP/RTP packets are received, they are placed in the ingress buffer 480, while the corresponding one of the virtual file buffers 490 stores a reference to where blocks of incoming data can be found (e.g., by way of, starting location and size) within the ingress buffer 480.

Also, at every frame (e.g., 10 ms), for every data session in a PLAYING state, if the timestamps of the UDP/RTP packets encapsulated within the next IP packet in the egress buffer 485 have elapsed, then:
mark the outgoing IP packet as “ready for send”, which results in the outgoing IP packet being transmitted over a data session 850 (event 822);
create a new IP header. Specifically, the information received in the SETUP connection and control message is used to identify the destination address and ports as those of media client 106A. Optionally, this new IP header identifies the source address as the IP address of the media control server 124;
copy the contents of a UDP/RTP packet from the ingress buffer 480 using the references in the virtual file buffer;
append the new IP header;
place in the egress buffer 485;
increase the read position in the corresponding one of the virtual file buffers 490;
mark the space occupied by the no longer used packets in the ingress buffer 480 as free.

IP packets transmitted over the data session 850 are then sent to the media client via the router or switch 122 and the media delivery network 102 in the appropriate manner. Where the data path subsystem 406 did not use the source address as the IP address of the media control server 124, this may be done by the router or switch 122 as the IP packets traverse the router or switch 122 on their way out towards the media delivery network 102. In this way, the IP packets traversing the media delivery network 102 will appear to have been sent by the media control server 124 even though they were sent by data path device 126B.

Since operation of the data path subsystem 406 does not involve communication with or through the media control server 124 over the control path 140, it should be appreciated that real-time streaming of media is unencumbered by slowdowns (e.g., due to operating system design and CPU-bound data movements) that may affect the media control server 124, while congestion on the media delivery network 102 will be unnoticeable.

It should also be reiterated that the files are created in storage for each supported resolution or format, thereby placing the media in a format that has been requested by, or is best suitable for, the media client 106A. This eliminates the need for transcoding or re-encoding the media as it is being transferred, yet again improving the speed with which media data can be streamed over the media delivery network 102 in a piecewise fashion.

Also, it will be appreciated that playback requires only a few seconds' worth of buffer storage per data session

Those skilled in the art will appreciate that other sequences of events occur in the case where end user 104A issues subsequent user commands over the media control session 830.

For example, where end user 104A chooses to pause playback of the particular movie, media client 106A sends a PAUSE user command over the media control session 830. In response, the connection and media control component 210 implements the Session.Pause method, which involves sending the PAUSE connection and media control command to data path device 126B. The state of the particular resource connection object is changed to IDLE. The media control server 124 acknowledges the PAUSE user command over the media control session 830 to media client 106A. In response to the PAUSE media connection and media control command, the connection and media control component 416 in the control path subsystem 402 of data path device 126B marks as “idle” the state entry that was previously created in the data session control structure 450 in the main memory 404, and which was previously linked with the entry in the file allocation table control structure 460 previously created at step 810.

Where end user 104A then chooses to resume playback of the particular movie, media client 106A sends a PLAY user command over the media control session 830. In response, the connection and media control component 210 implements the Session.Play method, which involves sending the PLAY connection and media control command to data path device 126B. The state of the particular resource connection object is changed back to PLAY. The media control server 124 acknowledges the PLAY user command over the media control session 830 to media client 106A. In response to the PLAY media connection and media control command, the connection and media control component 416 in the control path subsystem 402 of data path device 126B changes the state to PLAYING in the data session control structure 450 in the main memory 404.

Other commands such as skip forward and skip backward can also be implemented.

As has already been mentioned, certain ones of the control structures 408 are written to and read by the control path subsystem 402, while being strictly read by the data path subsystem 406. This is the case with the data session control structure 450 and the file allocation table control structure 460. Thus, a special access mechanism can be used in order not to delay access by the data path subsystem 406 to these control structures 450, 460 during the real-time streaming cycle, while allowing the control path subsystem 402 to update the control structures' content.

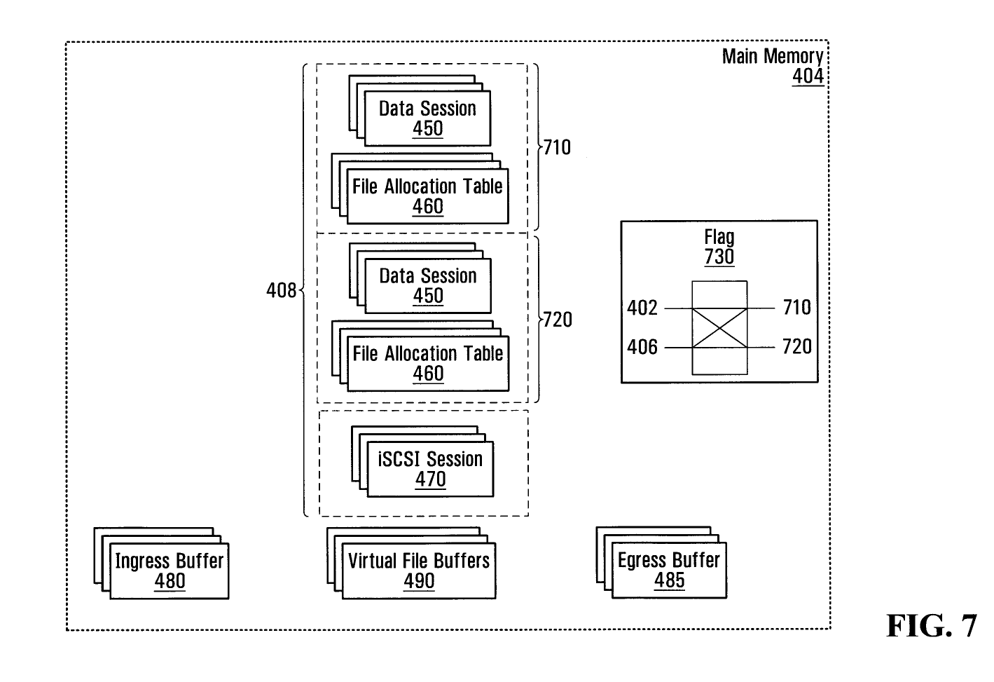

Such a shared access mechanism can be accomplished, as shown in FIG. 7, by duplicating the content of the control structures 450, 460 to provide two copies 710, 720 so that one copy is owned by the control path subsystem 402 and the other copy is owned by the data path subsystem 406 at a single point in time. Which copy (710 or 720) is currently owned by which subsystem (402 or 406) is controlled by the data path subsystem 406 by changing a flag 730 stored in the main memory 404 outside the two sets of control structures 710, 720.

Additionally, the data path subsystem 406 can regularly check (e.g., once per second) if the control path subsystem 402 is accessing its copy (e.g., 710) of the control structures 450, 460. This check is performed at the end of a real-time streaming cycle of the data path subsystem 406 so that it does not affect the real-time behavior of the data path subsystem 406. In case the control path subsystem 402 is not in the process of updating its copy 710, the data path subsystem 406 blocks the control path subsystem's access and makes the switch between the references to the two sets of control structures 710, 720 such that the data path subsystem 406 thereafter uses copy 710 (which was formerly the control path subsystem's version) and the control path subsystem 402 uses copy 720 (which was formerly the data path subsystem's version).

Once the switching event occurs, the control path subsystem 402 will now be referring to an out-of-date version of the control structures 450, 460 and therefore proceeds to update its (new) copy 720 of the control structures 450, 460 based on the version 710 of the control structures 450, 460 now being used by the data path subsystem 406, and which had been kept up-to-date by the control path subsystem 402 until just before the switching event. The control path subsystem 402 then proceeds to update the control structures' content based on events such as the connection and media control commands 222 received from the resources component 204 of the media control server 124.

It should be appreciated that the present invention does not preclude the use of additional optimization techniques to improve overall performance. For example, smart storage caching methods can be used in the media storage entity 128 in such a way that it is optimized for this delivery of media in the manner described above.

Those skilled in the art will appreciate that in some embodiments, the functionality of the media control server 124 and/or the data path devices 126 may be implemented using pre-programmed hardware or firmware elements (e.g., field-programmable gate array (FPGA), application specific integrated circuits (ASICs), etc.), or other related components. In other embodiments, the functionality of the media control server 124 and/or the data path devices 126 may be achieved using a computing apparatus that has access to a code memory (not shown) which stores computer-readable program code for operation of the computing apparatus, in which case the computer-readable program code could be stored on a medium which is fixed, tangible and readable directly by the media control server 124 and/or the data path devices 126, (e.g., removable diskette, CD-ROM, ROM, fixed disk, USB drive), or the computer-readable program code could be stored remotely but transmittable to the media control server 124 and/or the data path devices 126 via a modem or other interface device (e.g., a communications adapter) connected to a network (including, without limitation, the Internet) over a transmission medium, which may be either a non-wireless medium (e.g., optical or analog communications lines) or a wireless medium (e.g., microwave, infrared or other transmission schemes) or a combination thereof.

While specific embodiments of the present invention have been described and illustrated, it will be apparent to those skilled in the art that numerous modifications and variations can be made without departing from the scope of the invention as defined in the appended claims.

What is claimed is:

1. A data path device, comprising:
an interface configured to receive object location information from a control entity in communication with a client over a control session, said object location information allowing retrieval of a media object from a media storage entity; and
a data path subsystem configured to effect piecewise retrieval of said media object from said media storage entity based on said object location information and to effect piecewise transmission of said media object to said client over a data session separate from said control session.

2. The data path device defined in claim 1, further comprising a control path subsystem in communication with the control entity over a control path.

3. The data path device defined in claim 2, the control path passing through a router or switch.

4. The data path device defined in claim 2, the control session traversing a network.

5. The data path device defined in claim 4, wherein the network comprises the Internet.

6. The data path device defined in claim 4, wherein the network comprises a last mile access network.

7. The data path device defined in claim 6, wherein the data path device is co-located with said client.

8. The data path device defined in claim 2, wherein said data path device is co-located with said control entity.

9. The data path device defined in claim 2, further comprising a memory that stores an ingress buffer and an egress buffer.

10. The data path device defined in claim 9, wherein first packets containing portions of said media object that are retrieved from said media storage entity are stored in the ingress buffer and wherein second packets containing portions of said media object that are to be transmitted to said client are stored in the egress buffer prior to transmission over the data session.

11. The data path device defined in claim 10, wherein said egress buffer is a virtual buffer.

12. The data path device defined in claim 10, wherein to effect piecewise retrieval of said media object from said media storage entity, said data path subsystem is configured to communicate with at least one storage device over a data/control path.

13. The data path device defined in claim 12, wherein communication over the data/control path occurs in accordance with the iSCSI protocol.

14. The data path device defined in claim 10, wherein the data path subsystem implements real-time streaming cycles during which the data path subsystem is configured to effect transmission of those of the second packets that have expired.

15. The data path device defined in claim 14, wherein the data path subsystem is configured to identify the second packets as being destined for said client.

16. The data path device defined in claim 15, wherein the data path subsystem is configured to identify the second packets as originating from said control entity.

17. The data path device defined in claim 14, wherein during the real-time streaming cycles the data path subsystem is configured to transfer one or more the first packets in the ingress buffer into the second buffer to replace certain ones of the second packets in the egress buffer having undergone transmission.

18. The data path device defined in claim 17, wherein during the real-time streaming cycles the data path subsystem is configured to coordinate retrieval of portions of said media object from said media storage entity and placement thereof into the ingress buffer to replace certain ones of the first packets that have been transferred to the egress buffer.

19. The data path device defined in claim 18, wherein the memory stores a virtual file buffer associated with said media object to keep track of where in the ingress buffer are located those said first packets containing portions of said media object that have not yet been transferred to the egress buffer.

20. The data path device defined in claim 19, wherein the memory further stores a control structure that includes a file allocation table indicative of said object location information.

21. The data path device defined in claim 20, wherein the control structure further includes information regarding said data session.

22. The data path device defined in claim 21, wherein the information regarding said data session includes an address associated with said client and an identification of a port used by said client.

23. The data path device defined in claim 22, wherein the second packets comprise versions of the first packets encapsulated with a respective header.

24. The data path device defined in claim 23, wherein the header is an IP header.

25. The data path device defined in claim 24, wherein the IP header includes the address associated with said client and an identification of the port used by said client.

26. The data path device defined in claim 20, wherein the memory stores plural versions of the control structure.

27. The data path device defined in claim 26, during the real-time streaming cycles the data path subsystem utilizes a current version of said object location information.

28. The data path device defined in claim 27, wherein the current version of said object location information is one of said plural versions of said object location information as defined by a flag.

29. The data path device defined in claim 28, wherein said flag is stored in the memory.

30. The data path device defined in claim 29, wherein said data path subsystem is configured to change said flag, thereby to re-define which version of said object location information is the current version of said object location information.

31. The data path device defined in claim 30, said interface being configured to receive updates of said control structure including said object location information.

32. The data path device defined in claim 31, said interface being configured to allow updating of a version of said object information other than the current version of said object location information, and to disallow updating of the current version of said object location information.

33. The data path device defined in claim 32, wherein said data path subsystem is configured to change said flag on a regular basis.

34. A data path device, comprising:
means for receiving object location information from a control entity in communication with a client over a control session, said object location information allowing retrieval of a media object from a media storage entity;
means for effecting piecewise retrieval of said media object from said media storage entity based on said object location information; and
means for effecting piecewise transmission of said media object to said client over a data session separate from said control session.

35. A method, comprising:
receiving object location information from a control entity in communication with a client over a control session, said object location information allowing retrieval of a media object from a media storage entity;
effecting piecewise retrieval of said media object from said media storage entity based on said object location information; and
effecting piecewise transmission of said media object to said client over a data session separate from said control session.

36. A media delivery platform, comprising:
a control entity; and
a data path entity;
said control entity configured for:
receiving over a control session media action commands from a client, said media action commands specifying a media object stored in a media storage entity;
determining object location information allowing the specified media object to be retrieved from said media storage entity; and
providing said data path entity with said object location information;
said data path entity configured for:
piecewise retrieval of said media object from said media storage entity based on said object location information; and
piecewise transmission of said media object to said client, said transmission being effected over a data session separate from said control session.

37. The media delivery platform defined in claim 36, wherein the media action commands comprise a first command to identify the media object and a second command to initiate playback of media.

38. The media delivery platform defined in claim 37, wherein the first command is a SETUP command and the second command is a PLAY command, in accordance with a version of the RTSP protocol.

39. The media delivery platform defined in claim 36, wherein the control entity is configured to manage a parent object associated with the data path entity.

40. The media delivery platform defined in claim 39, wherein the control entity is configured to implement a resource discovery component to monitor a condition of the data path entity.

41. The media delivery platform defined in claim 40, wherein the parent object associated with the data path entity is created upon detection of the data path entity by the resource discovery component.

42. The media delivery platform defined in claim 39, wherein the control entity is configured to create a child object of the parent object, said child object associated with the data session, said child object being indicative of a state of the data session.

43. The media delivery platform defined in claim 42, wherein the state of the data session is one of PLAYING, IDLE and NULL.

44. The media delivery platform defined in claim 43, wherein the control entity implements a connection and media control component configured to send connection and media control commands to the data path entity.

45. The media delivery platform defined in claim 44, wherein the connection and media control component is configured to send the connection and media control commands upon changes in the state of the data session.

46. The media delivery platform defined in claim 45, wherein the connection and media control component is configured to send a PLAY command upon a change in the state of the data session to PLAYING, the PLAY command including said object location information.

47. The media delivery platform defined in claim 36, wherein said control entity is in communication with said data path entity over a control path.

48. The media delivery platform defined in claim 47, wherein the transmission of said media object to said client occurs via a router or switch connected to the data path entity.

49. The media delivery platform defined in claim 48, wherein the control path passes through said router or switch.

50. The media delivery platform defined in claim 47, wherein the control session traverses a network.

51. The media delivery platform defined in claim 50, wherein the network comprises the Internet.

52. The media delivery platform defined in claim 50, wherein the network comprises a last mile access network.

53. The media delivery platform defined in claim 52, wherein said data path entity is co-located with said client.

54. The media delivery platform defined in claim 47, wherein said data path entity is co-located with said control entity.

55. The media delivery platform defined in claim 48, wherein transmission of said media object to said client is in the form of IP packets.

56. The media delivery platform defined in claim 55, wherein the IP packets contain encapsulated UDP/RTP packets.

57. The media delivery platform defined in claim 55, wherein the IP packets contain encapsulated I-TDM packets.

58. The media delivery platform defined in claim 55, wherein said data path entity is configured to identify the IP packets as being destined for said client.

59. The media delivery platform defined in claim 58, wherein said data path entity is configured to identify the IP packets as originating from said control entity.

60. The media delivery platform defined in claim 36, wherein the media storage entity comprises at least one storage device, and wherein the object location information specifies at least one memory block in at least of the at least one storage device.

61. The media delivery platform defined in claim 60, wherein the media storage entity comprises plural storage devices arranged in a storage area network, and wherein the object location information specifies at least one memory block in at least one of the storage devices.

62. The media delivery platform defined in claim 61, wherein the media storage entity comprises plural storage devices, and wherein the object location information specifies plural memory blocks in at least one of the storage devices.

63. The media delivery platform defined in claim 62, wherein the media storage entity comprises plural storage devices, and wherein the object location information specifies plural memory blocks in plural ones of the storage devices.

64. The media delivery platform defined in claim 36, wherein the data path entity comprises a memory that stores an ingress buffer and an egress buffer.

65. The media delivery platform defined in claim 64, wherein first packets containing portions of said media object that are retrieved from said media storage entity are stored in the ingress buffer and wherein second packets containing portions of said media object that are to be transmitted to said client are stored in the egress buffer prior to transmission over the data session.

66. The media delivery platform defined in claim 65, wherein to effect piecewise retrieval of said media object from said media storage entity, said data path entity is configured to communicate with at least one storage device over a data/control path.

67. The media delivery platform defined in claim 66, wherein communication over the data/control path occurs in accordance with the iSCSI protocol.

68. The media delivery platform defined in claim 65, wherein the data path entity implements real-time streaming cycles during which the data path entity is configured to effect transmission of those of the second packets that have expired.

69. The media delivery platform defined in claim 68, wherein during the real-time streaming cycles the data path entity is configured to transfer one or more the first packets in the ingress buffer into the second buffer to replace certain ones of the second packets in the egress buffer having undergone transmission.

70. The media delivery platform defined in claim 69, wherein during the real-time streaming cycles the data path entity is configured to coordinate retrieval of portions of said media object from said media storage entity and placement thereof into the ingress buffer to replace certain ones of the first packets that have been transferred to the egress buffer.

71. The media delivery platform defined in claim 70, wherein the memory stores a virtual file buffer associated with said media object to keep track of where in the ingress buffer are located those said first packets containing portions of said media object that have not yet been transferred to the egress buffer.

72. The media delivery platform defined in claim 60, wherein the memory further stores a control structure that includes a file allocation table indicative of said object location information.

73. The media delivery platform defined in claim 72, wherein the memory stores plural versions of the control structure.

74. The media delivery platform defined in claim 73, during the real-time streaming cycles the data path entity utilizes a current version of said object location information.

75. The media delivery platform defined in claim 74, wherein the current version of said object location information is one of said plural versions of said object location information as defined by a flag.

76. The media delivery platform defined in claim 75, wherein said flag is stored in the memory.

77. The media delivery platform defined in claim 76, wherein said data path entity is configured to change said flag, thereby to re-define which version of said object location information is the current version of said object location information.

78. The media delivery platform defined in claim 77, wherein the data path entity comprises an interface configured to receive updates of said control structure including said object location information.

79. The media delivery platform defined in claim 78, said interface being configured to allow updating of a version of said object information other than the current version of said object location information, and to disallow updating of the current version of said object location information.

80. The media delivery platform defined in claim 79, wherein said data path entity is configured to change said flag on a regular basis.

81. The media delivery platform defined in claim 36, wherein said data path entity comprises a plurality of data path devices.

82. The media delivery platform defined in claim 81, wherein said data path devices occupy respective slots in a chassis.

83. The media delivery platform defined in claim 36, wherein said data path entity and said control entity are integrated on a common chip.

84. A media delivery platform, comprising:
means for receiving over a control session media action commands from a client, said media action commands specifying a media object stored in a media storage entity;
means for determining object location information allowing the specified media object to be retrieved from said media storage entity;
means for effecting piecewise retrieval of said media object from said media storage entity based on said object location information; and
means for effecting piecewise transmission of said media object to said client, said transmission being effected over a data session separate from said control session.

85. A method, comprising:
receiving over a control session media action commands from a client, said media action commands specifying a media object stored in a media storage entity;
determining object location information allowing the specified media object to be retrieved from said media storage entity;
effecting piecewise retrieval of said media object from said media storage entity based on said object location information; and
effecting piecewise transmission of said media object to said client, said transmission being effected over a data session separate from said control session.

86. A method for delivery of stored media to a client, comprising:
receiving commands sent by a media client over a control session;
retrieving stored media from a media storage entity based on said commands; and
delivering the retrieved media to said media client over a data session that is separate from the control session.

87. A method for execution at a media client, comprising:
sending media commands to a control entity over a control session established with the control entity; and
receiving streamed media from a data path entity over a data session established with the data path entity, the streamed media having bypassed the control entity while identifying the control entity as an originator of the streamed media.

88. The method defined in claim 87, wherein both the control session and the data session traverse the Internet.

89. The method defined in claim 87, wherein the control session traverses the Internet and wherein the data session does not traverse the Internet.

90. A media client comprising:
a media engine configured to send media commands to a control entity over a control session established with the control entity, and to receive streamed media from a data path entity over a data session established with the data path entity, the streamed media having bypassed the control entity while identifying the control entity as an originator of the streamed media.

91. The media client defined in claim 90, implemented in a computing apparatus.

92. The media client defined in claim 90, implemented in at least one of a mobile phone and a handheld personal digital assistant.

93. The media client defined in claim 90, implemented in a television set-top box.

94. A bank of data path devices, each said data path being independently accessible and comprising:
a respective interface configured to receive object location information from a control entity in communication with a client over a control session, said object location information allowing retrieval of a media object from a media storage entity; and
a respective data path subsystem configured to effect piecewise retrieval of said media object from said media storage entity based on said object location information and to effect piecewise transmission of said media object to said client over a data session separate from said control session.
